(19) United States
(12) Patent Application Publication
(10) Pub. No.: US 2014/0124341 A1
(43) Pub. Date: May 8, 2014

(54) TOUCH PANEL AND METHOD FOR MANUFACTURING THE SAME

(71) Applicant: SAMSUNG ELECTRO-MECHANICS CO., LTD., Suwon (KR)

(72) Inventor: Jang Ho Park, Suwon (KR)

(73) Assignee: SAMSUNG ELECTRO-MECHANICS CO., LTD., Suwon (KR)

(21) Appl. No.: 13/731,671

(22) Filed: Dec. 31, 2012

(30) Foreign Application Priority Data
Nov. 5, 2012 (KR) 10-2012-0124098

(51) Int. Cl. H01H 9/02

(52) U.S. Cl. CPC H01H 9/02
USPC 200/293; 427/58

(57) ABSTRACT

Disclosed herein is a touch panel including: a transparent substrate; and a bezel part including a white layer formed at one-side edge of the transparent substrate and a light-shielding layer formed on the white layer, wherein the bezel part has a narrow width and a thin thickness, thereby implementing a display screen larger than that of the other touch panels having the same exterior size and providing the touch panel including the white-colored bezel part having a thin thickness and a uniform and sufficient color.

### CROSS REFERENCE TO RELATED APPLICATION

This application claims the benefit of Korean Patent Application No. 10-2012-0124098, filed on Nov. 5, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel and a method for manufacturing the same.

2. Description of the Related Art

In accordance with the growth of a computer using a digital technology, devices assisting computers have also been developed, and a personal computer, a portable transmitter, other personal information processors, and the like, execute processing of text and graphics using various input devices such as a keyboard and a mouse.

While the rapid advancement of the information-based society has been widening the use of computers more and more, it is difficult to efficiently operate products using only the keyboard and mouse as being currently responsible for the input device function. Therefore, necessity for a device which is simple, has less malfunction, and is capable of easily inputting information has increased.

Furthermore, a current technology for the input device exceeds the level of fulfilling general functions and is progressing towards technologies related to high reliability, durability, innovation, designing and manufacturing. To this end, a touch panel has been developed as an input device capable of inputting information such as text and graphics.

The touch panel is mounted on a display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classified into a resistive type, a capacitive type, an electromagnetic type, a surface acoustic wave (SAW) type, and an infrared type. These various types of touch panels are adapted for electronic products while considering a signal amplification problem, a resolution difference, the degree of difficulty of designing and processing technologies, an optical characteristic, an electrical characteristic, a mechanical characteristic, resistance to an environment, an input characteristic, durability, and economical efficiency. Currently, the resistive type touch panel and the capacitive type touch panel have been prominently used in a wide range of fields.

As an example of the touch panels, the touch panel may have a structure in which a transparent substrate and a sensing part are adhered via an adhesive, and may be formed so that a bezel part formed along an edge of the transparent substrate covers a bus line of the sensing part.

Recently, an exterior design of an information technology (IT) device has gradually become important, and a display screen thereof has become large. An area of the bezel part needs to be decreased than the case of the prior art in order to enlarge the display screen without an increase of an exterior size of the device and implement a full color which is a color closed to the original.

Patent Document disclosed in the prior art below discloses a bezel part provided with a black layer and a transparent conductive film (indium tin oxide: ITO).

Since demands of customers are various, various colors of the bezel parts as well as black colored bezel part described in the prior art below need to be supplied, and in particular, a white colored bezel part which provides a clean image and is preferred by women is in great demand.

A method for manufacturing the white colored bezel part of the prior art includes painting the exterior of the transparent substrate white or performing a screen printing method using a white ink or a white paste at a lower portion of the transparent substrate so that the white colored bezel part is formed in the touch panel while being integrally therewith. The latter method is preferable because the bezel part may have a narrow width and an external damage may be minimized.

However, in the screen printing method, since the white ink or the white paste has a limitation in density, it needs to be concentrated in order to increase the density; however, TiO₂ (Titanium Dioxide) which is mainly used as the white pigment has difficulty in being concentrated and needs to be repeatedly subject to printing several times. Here, since thickness obtained after the printing method is performed once is at least 5 μm or more, it is difficult to implement the bezel part having the narrow width and to implement the touch sensor having a fine line width thinner than 40 μm.

In order to solve the problem, development of a thin white colored bezel part having a narrow width using a photosensitive white ink has been conducted; however, since a particle power size, a density composition, or the like, of the white ink such as TiO2 lacks uniformity, a problem that whiteness is not uniform and sufficient still exists.

A resin-based white ink has been generally applied. The resin-based white ink is produced by a screen printing method, and more specifically, by performing screening several times to increase the whiteness and prevent light transmission. However, since the formed bezel part has a thickness of 15 μm or more, and large surface roughness, it is difficult to implement a fine pattern. Therefore, a screen layer and a taper layer are formed to improve connectivity of an electrode wiring, thereby achieving flatness and being connected to a thin electrode layer (thinner than 200 nm). As such, since application of the screen printing method causes problems such as repeatedly performing the screen printing method, a thick thickness, a tapered structure, or the like, it is difficult to implement the bezel part having a narrow width.

### PRIOR ART DOCUMENT

### Patent Document

(Patent Document 1) Korean Patent Laid-Open Publication No. 10-2011-0053940 (Laid-Open Publication Date: May 24, 2011)

### SUMMARY OF THE INVENTION

The present invention has been made in an effort to provide a touch panel capable of maximizing a display screen without increasing the entire size of the touch panel by decreasing an area of a bezel part of the touch panel and a method for manufacturing the same.

Further, the present invention has been made in an effort to provide a thin touch panel by implementing the bezel part thereof having a thin thickness and a method for manufacturing the same.

Still further, the present invention has been made in an effort to provide a touch panel including a bezel part having a uniform and sufficient color and a method for manufacturing the same.

According to a preferred embodiment of the present invention, there is provided a touch panel including: a transparent substrate; and a bezel part including a white layer formed at an edge of the transparent substrate and a light-shielding layer formed on the white layer.

The light-shielding layer may be made of a silver-white colored metal or an alloy thereof.

The light-shielding layer may be made of any one of titanium-based oxide (TiO₂,), aluminum-based oxide (Al₂0₃), and silicon-based oxide (SiO₂), or a combination thereof.

The light-shielding layer may have a thickness of 0.1 to 1,m, and more preferably, a thickness of 250 to 400 nm.

The light-shielding layer may include an insulating layer.

The light-shielding layer may be formed by any one of a vapor deposition method, an atomic layer deposition method, and a sol-gel method.

The white layer may be made of any one of titanium-based oxide (TiO₂,), aluminum-based oxide (Al₂0₃), magnesium-based oxide (MgO), sodium-based oxide (Na₂O), lithium-based oxide (Li₂O), beryllium-based oxide (BeO), silicon-based oxide (SiO₂), magnesium-based sulfide (MgS), MgF₂, MgCo₃, ZnO, ZnS, KNO₃, KCl, KOH, Ga₂O₃, RbCl, RbF, BaTiO₃, BaSO₄, BaCl₂, BaO, Ba(NO₃)₂, BaCO₃, BaOH, BaB₂O₄, SrTiO₃, SrCl₂, SrO, Y₂O₃, YCl₃, YF₃, ZrO₂, ZrCl₄, ZrF₄, Nb₂O₅, NbOCl₃, Mo(CO)₆, CdCl₂, InCl₃, SnO₂, Sb₂O₃, CsI, CsCl, CsF, Ta₂O₅, TaCl₅, and TaF₅, or a combination thereof.

The white layer may be formed by any one of a spin coating, a roll coating, and a slot coating.

The bezel part may be formed to have a thickness thinner than 10 μm.

According to another preferred embodiment of the present invention, there is provided a method for manufacturing a touch panel, the method including: (A) preparing a transparent substrate; (B) forming a white layer at an edge of the transparent substrate; and (C) coating a light-shielding layer on the white layer.

In step (B), the white layer may be formed by any one of a spin coating, a roll coating, and a slot coating.

In step (C), the light-shielding layer may be formed by any one of a vapor deposition method, an atomic layer deposition method, and a sol-gel method.

In step (C), the light-shielding layer may be pattern-treated so as to have surface roughness.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a touch panel according to a preferred embodiment of the present invention;

FIG. 2 is a cross-sectional view of a bezel part configuring the touch panel according to the preferred embodiment of the present invention;

FIG. 3 is a cross-sectional view of the bezel part configuring a touch panel according to another preferred embodiment of the present invention; and

FIG. 4 is a flow chart showing a process of manufacturing the touch panel according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

For reference, a term ‘touch’ used throughout the specification is widely interpreted as allowing an input unit to be close to a contact receiving surface by considerable distance as well as being in direct contact with a contact receiving surface. That is, it is interpreted that the touch panel according to the preferred embodiment of the present invention is a touch panel having a function recognizing the contact of the input unit, or recognizing the proximity within considerable distance.

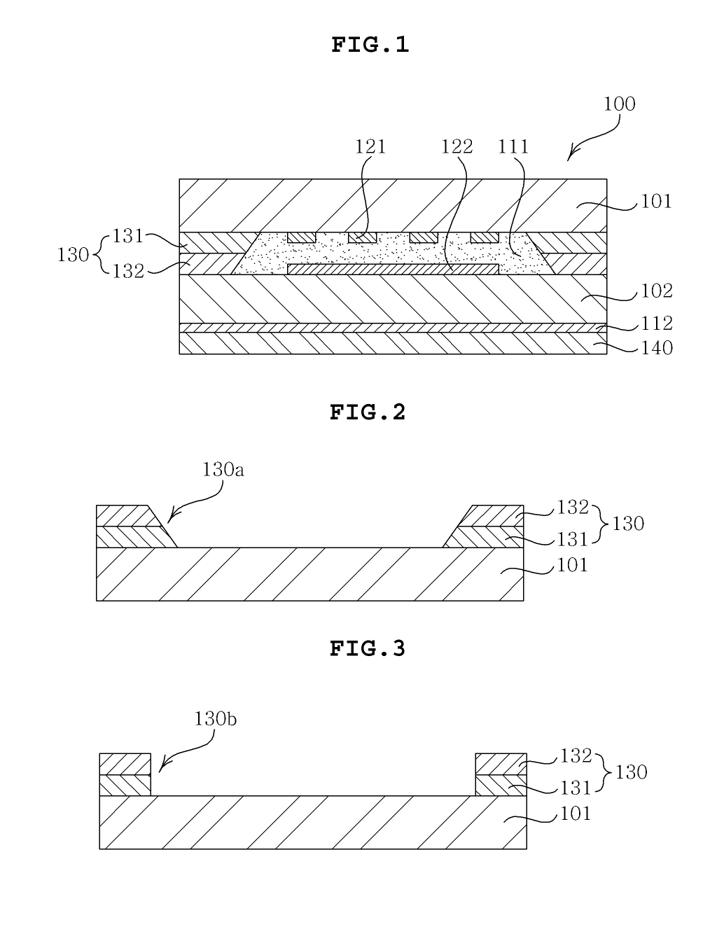

Hereinafter, preferred embodiments of the present invention will be described in detail with reference to the accompanying drawings. FIG. 1 is a cross-sectional view of a touch panel according to a preferred embodiment of the present invention; FIG. 2 is a cross-sectional view of a bezel part configuring the touch panel according to the preferred embodiment of the present invention; and FIG. 3 is a cross-sectional view of the bezel part configuring a touch panel according to another preferred embodiment of the present invention.

The touch panel 100 according to the preferred embodiment of the present invention includes a first transparent substrate 101 being partitioned into an active region and a non-active region surrounding the active region, a second transparent substrate 102 adhered to one surface of the first transparent substrate 101 via an insulating layer 111, a bezel part 130 disposed between the first transparent substrate 101 and the second transparent substrate 102, and an anti-reflective layer 140 adhered to one surface of the second transparent substrate 102 via an adhesive layer 112 as shown in FIG. 1.

The transparent substrates 101 and 102, which are partitioned into the active region and the non-active region surrounding the active region, the active region being a screen region in which an operation screen of a device is visually confirmed by a touch of a user, needs to have transparency. In consideration of the transparency, the transparent substrates 101 and 102 may be made of polyethylene terephthalate (PET), polycarbonate (PC), polymethylmethacrylate (PMMA), polyethylene naphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass, or the like, but is not necessarily limited thereto.

According to the preferred embodiment of the present invention and referring to FIG. 1, the transparent substrates 101 and 102 may include the first transparent substrate 101 and the second transparent substrate 102, and is provided with a first electrode pattern 121 formed on one surface of the active region of the first transparent 101, a first bus line (not-shown) connected to the first electrode pattern 121 in the non-active region of the first transparent substrate 101, a second electrode pattern 122 formed on the other surface of the active region of the second transparent substrate 102 corresponding to the first electrode pattern 121, and a second bus line (not-shown) connected to the second electrode pattern 122 and formed in the non-active region of the second transparent substrate 102.

Here, the first electrode pattern 121 may be a sensing electrode pattern, and the second electrode pattern 122 may be a driving electrode pattern intersected with the first electrode pattern 121. On the contrary, the first electrode pattern 121 may be a driving electrode pattern, and the second electrode pattern 122 may be a sensing electrode pattern.

In the preferred embodiment of the present invention according to FIG. 1, the first transparent substrate 101 may be a window provided in the outermost side of the touch panel. Here, an exposed surface (a surface that is opposite to one surface of the transparent substrate having the electrode pattern formed thereon) of the first transparent substrate 101 receives a touch by a user. As such, in the case in which the transparent substrate 101 is the window, the first electrode pattern 121 is formed directly on the window, such that a process of forming the electrode pattern on a separate transparent substrate and then attaching the transparent substrate to the window is omitted, thereby making it possible to simplify a manufacturing process and reduce the entire thickness of the touch panel.

The first transparent substrate 101 is provided is a bezel part 130 corresponding to the first bus line (not-shown) in the non-active region.

More particularly, the bezel part 130 may be formed by being printed with color inks including black, white, gold, red, green, yellow, gray, purple, brown, blue, or a combination thereof, or the like, by various printing methods such as a screen printing method, a roll coating method, and the like and then performing an etching method, a transcription method using a roller or a stamp, or a compression method using a press.

Here, the narrower the width of the bezel part 130, the wider the active region corresponding to a screen region, which is preferable. In addition, it is preferable that the bezel part 130 is formed in a white color which provides a clean image and is preferred by women. Further, in the case in which the bezel part 130 having a thin thickness may be formed, a thin touch panel may be implemented.

In the case of a white pigment layer, a film thickness thereof is preferably thin when considering the case of a white pigment layer, adhesion with a lower layer, stress in accordance with a thickness, or the like; however, the film thickness thereof needs to be thick when considering whiteness (color), a light-shield effect.

As described above, according to the preferred embodiment of the present invention, the bezel part 130 includes the white layer 131 thinly coated with a white ink and a separate light-shielding layer 132 coated for providing the whiteness thereon and decreasing light transmittance in order to be thin and maintain the color and the light shielding property as shown in FIG. 2.

The white layer 131 may be made of any one of titanium-based oxide (TiO₂,), aluminum-based oxide (Al₂0₃), magnesium-based oxide (MgO), sodium-based oxide (Na₂O), lithium-based oxide (Li₂O), beryllium-based oxide (BeO), silicon-based oxide (SiO₂), magnesium-based sulfide(MgS), MgF₂, MgCo₃, ZnO, ZnS, KNO₃, KCl, KOH, Ga₂O₃, RbCl, RbF, BaTiO₃, BaSO₄, BaCl₂, BaO, Ba(NO₃)₂, BaCO₃, BaOH, BaB₂O₄, SrTiO₃, SrCl₂, SrO, Y₂O₃, YCl₃, YF₃, ZrO₂, ZrCl₄, ZrF₄, Nb₂O₅, NbOCl₃, Mo(CO)₆, CdCl₂, InCl₃, SnO₂, Sb₂O₃, CsI, CsF, Ta₂O₅, TaCl₅, and TaF₅, or a combination thereof.

The light-shielding layer 132 may be formed using a silver-white colored metal such as Al, Ti, Mo, Ag, Cr, or the like, or an alloy similar thereto. In addition, the light-shielding layer 132 may be made of titanium-based oxide (TiO₂,), aluminum-based oxide (Al203), or silicon-based oxide (SiO₂). In the case in which the light-shielding layer 132 is made of an oxide, it is formed by forming a single film and then performing an oxidation process as a separate process. In addition, in the case in which the light-shielding layer 132 is made of a metal, the insulating layer may be formed for metal wiring of a touch sensor. Accordingly, the thin bezel part 130 having several μm thickness may be implemented.

Here, the insulating layer may be included in the case in which the light-shielding layer is made of an oxide as well as the case in which the light-shielding layer is made of metal. In addition, the insulating layer may be replaced with the light-shielding layer 132.

In the bezel part 130 according to the preferred embodiment of the present invention, high-density coating is separately performed on corresponding materials for uniform dispersion of the light-shielding layer 132, such that nonuniformity of a space generated at the time of using an ink or a paste is reduced and the bezel part 130 having a thin thickness is formed. In order to achieve it, the light-shielding layer 132 may be preferably coated in a thickness of 0.1 to 1 μm when considering the adhesion with the white color. More preferably, the light-shielding layer 132 may be formed in a thickness of 250 to 400 nm.

In a method for coating the light-shielding layer 132, the light-shielding layer 132 may be uniformly coated at a low temperature. Therefore, a physical vapor deposition (PVD) method such as sputtering, a vacuum deposition, or the like, a chemical vapor deposition (CVD) method such as plasma-enhanced chemical vapor deposition (PECVD), metalorganic chemical vapor deposition (MOCVD), or the like, an atomic layer deposition (ALD) method, and a sol-gel method may be used to coat the light-shielding layer.

Meanwhile, since the color of the light-shielding layer 132 is improved in accordance with the surface roughness, a pattern treatment may be preferably performed so as to provide surface roughness.

In addition, the white layer 131 may be preferably thinned by a spin coating, a roll coating, a slot coating, or the like. As a material of the white layer 131, an organic photosensitive material capable of being performed by an exposure process is preferred.

The insulating layer 111 serves to protect the first electrode pattern 121 and the second electrode pattern 122. Here, the insulating layer 111 may be made of an organic insulating film or an inorganic insulating film by a printing method, a CVD method, sputtering, or the like.

Here, the insulating layer may be made of an epoxy or acrylic based resin, a SiOx thin film, or a SiNx thin film.

Referring to FIGS. 2 and 3, a cross-sectional part of the bezel part according to the preferred embodiment of the present invention may be sloped so as to have a tapered part 130a, and be formed in a vertical direction so as to have an orthogonal part 130b. The case where the cross-sectional part of the bezel part has the orthogonal part 130b is preferred for implementing a large screen; however, when considering efficiency in the manufacturing process, it is preferred that the cross-sectional part thereof has the tapered part 130a.

A lower part of the touch panel 100 is mounted with an image display device (not shown).

Herein, the image display device serves to output an image and includes a liquid crystal display device (LCD), a plasma display panel (PDP), an electroluminescence (EL), a cathode ray tube (CRT), or the like.

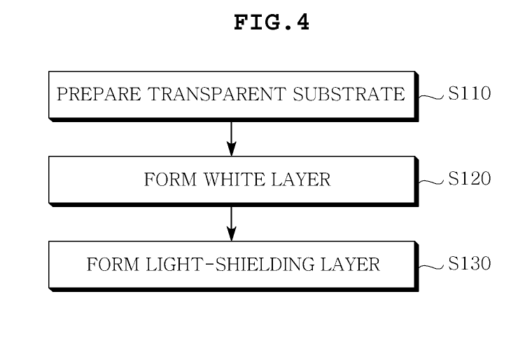

Meanwhile, FIG. 4 is a flow chart showing a process of manufacturing the touch panel according to the preferred embodiment of the present invention.

Referring to FIG. 4, a transparent substrate made of a transparent material is first prepared in the method for manufacturing the touch panel according to the preferred embodiment of the present invention (S110).

After preparing the transparent substrate, the white layer is formed at an edge of one-side surface of the transparent substrate (S120).

More specifically, forming the white layer (S120) may be performed by a spin coating method, a roll coating method, or a slot coating method. The white layer may be preferably made of a photosensitive material.

Next, the light-shielding layer is coated on the white layer (S130).

In coating the light-shielding layer (S130), a physical vapor deposition (PVD) method such as sputtering, a vacuum deposition, or the like, a chemical vapor deposition (CVD) method such as plasma-enhanced chemical vapor deposition (PECVD), metalorganic chemical vapor deposition (MOCVD), or the like, an atomic layer deposition (ALD) method, and a sol-gel method may be used.

Here, a pattern treatment such as an etching process or a desmear process may be further performed so that the light-shielding layer has a predetermined surface roughness. When the pattern treatment is performed as described above, the surface of the light-shielding layer is nonuniformly formed.

In addition, if needed, the insulating layer may be further formed, after the light-shielding layer is coated (S130).

The light-shielding layer may be formed using a silver-white colored metal such as Al, Ti, Mo, Ag, Cr, or the like, or an alloy similar thereto. In addition, the light-shielding layer may be made of titanium-based oxide (TiO₂,), aluminum-based oxide (Al₂0₃), or silicon-based oxide (SiO₂), and in the case in which the light-shielding layer is made of an oxide, an oxidation process is needed.

By the above-described processes, the white bezel part made of a thin film and having a narrow width may be formed.

According to the preferred embodiment of the present invention, a capacitive touch panel has been exemplified; however, the present invention may also be applied to various types of touch panels, such as a resistive type of a touch panel.

As set forth above, with the touch panel according to the present invention, the bezel part including the white layer and the light-shielding layer and having the narrow width is formed, thereby making it possible to maximize the display screen. In addition, the bezel part of the touch panel is implemented with the thin thickness, thereby making it possible to provide the thin touch panel.

In addition, with the touch panel according to the present invention, the white layer and the light-shielding layer are coated as a separate layer, thereby making it possible to provide the touch panel including the white colored bezel part having the uniform and sufficient color.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising:
a transparent substrate; and
a bezel part including a white layer formed at an edge of the transparent substrate and a light-shielding layer formed on the white layer.

2. The touch panel as set forth in claim 1, wherein the light-shielding layer is made of a silver-white colored metal or an alloy thereof.

3. The touch panel as set forth in claim 1, wherein the light-shielding layer is made of any one of titanium-based oxide (TiO₂,), aluminum-based oxide (Al₂0₃), and silicon-based oxide (SiO₂), or a combination thereof.

4. The touch panel as set forth in claim 1, wherein the light-shielding layer has a thickness of 0.1 to 1 μm.

5. The touch panel as set forth in claim 4, wherein the light-shielding layer has a thickness of 250 to 400 nm.

6. The touch panel as set forth in claim 1, wherein the light-shielding layer includes an insulating layer.

7. The touch panel as set forth in claim 1, wherein the light-shielding layer is formed by any one of a vapor deposition method, an atomic layer deposition method, and a sol-gel method.

8. The touch panel as set forth in claim 1, wherein the white layer is made of any one of titanium-based oxide (TiO₂,), aluminum-based oxide (Al₂0₃), magnesium-based oxide (MgO), sodium-based oxide (Na₂O), lithium-based oxide (Li₂O), beryllium-based oxide (BeO), silicon-based oxide (SiO₂), magnesium-based sulfide (MgS), MgF₂, MgCo₃, ZnO, ZnS, KNO₃, KCl, KOH, Ga₂O₃, RbCl, RbF, BaTiO₃, BaSO₄, BaCl₂, BaO, Ba(NO₃)₂, BaCO₃, BaOH, BaB₂O₄, SrTiO₃, SrCl₂, SrO, Y₂O₃, YCl₃, YF₃, ZrO₂, ZrCl₄, ZrF₄, Nb₂O₅, NbOCl₃, Mo(CO)₆, CdCl₂, InCl₃, SnO₂, Sb₂O₃, CsI, CsCl, CsF, Ta₂O₅, TaCl₅, and TaF₅, or a combination thereof.

9. The touch panel as set forth in claim 1, wherein the white layer is formed by any one of a spin coating, a roll coating, and a slot coating.

10. The touch panel as set forth in claim 1, wherein the bezel part is formed to have a thickness thinner than 10 μm.

11. A method for manufacturing a touch panel, the method comprising:
(A) preparing a transparent substrate;
(B) forming a white layer at an edge of the transparent substrate; and
(C) coating a light-shielding layer on the white layer.

12. The method as set forth in claim 11, wherein in step (B), the white layer is formed by any one of a spin coating, a roll coating, and a slot coating.

13. The method as set forth in claim 11, wherein in step (C), the light-shielding layer is formed by any one of a vapor deposition method, an atomic layer deposition method, and a sol-gel method.

14. The method as set forth in claim 11, wherein in step (C), the light-shielding layer is pattern-treated so as to have surface roughness.
